(19) United States
(12) Patent Application Publication
(10) Pub. No.: US 2008/0310792 A1
(43) Pub. Date: Dec. 18, 2008

(54) Optical Fiber Sensor

(75) Inventors: Koji Ohtaka, Toyohashi-city (JP); Motomi Iyoda, Seto-city (JP); Yujiro Miyata, Kariya-city (JP); Ryotaro Kachu, Nishikamo-gun (JP); Hiroyuki Takahashi, Nishikamo-gun (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Aichi-pref. (JP); TOYOTA JIDOSHA KABUSHIKI KAISHA, Aichi-pref. (JP)

(21) Appl. No.: 11/886,186

(22) PCT Filed: Mar. 7, 2006
(86) PCT No.: PCT/JP2006/304846

§ 371 Date: Aug. 18, 2008

(30) Foreign Application Priority Data
Mar. 14, 2005 (JP) 2005-071596

(51) Int. Cl. G02B 6/00

(52) U.S. Cl. 385/13

(57) ABSTRACT

An optical fiber sensor (8) has an optical fiber (2) and, a light emitting member (3) connected to a first end (20) of the optical fiber (2), a light receiving member (4) connected to a second end (21) of the optical fiber (2). The light emitting member (3) has a light emitting portion (300) through which light is radiated to the first end (20) of the optical fiber (2). The light receiving member (4) has a light receiving portion (400) for receiving light radiated from the second end (21) of the optical fiber (2). The light emitting portion (300) is smaller than a sectional area of a core portion (25) of the optical fiber (2).

### TECHNICAL FIELD

The present invention relates to an optical fiber sensor having an optical fiber.

### BACKGROUND ART

In recent years, vehicles are required to improve safety of not only passengers but also pedestrians collided with the vehicles. It is known to have a pedestrian protection device on the vehicle for reducing harm to the pedestrian who may be fell over a bonnet of the vehicle by a collision. In the pedestrian protection device, it is significant to determine the collision of pedestrian. As one of means of detecting the collision of pedestrian, it is known to use a collision detecting sensor having an optical fiber sensor. The collision detecting sensor is for example mounted to a bumper of the vehicle.

The optical fiber sensor senses a stress applied to the optical fiber based on a change of light transmitting in the optical fiber. Generally, the optical fiber is deformed by an external stress, and a light transmitting characteristic of the optical fiber changes at the deformed portion. When the light transmitting characteristic of the optical fiber is partly changed, the light radiated from the optical fiber has a different characteristic such as strength and phase as a characteristic of the light before passing through the optical fiber. The optical fiber sensor detects the stress by using the change of the light transmitting characteristic.

The optical fiber sensor generally has a light emitting member for emitting a light into the optical fiber, and a light receiving member for receiving the light that has passed through the optical fiber. Further, the optical fiber sensor has a calculating part for calculating the stress applied to the optical fiber based on the characteristic of the light emitted from the light emitting member and the characteristic of the light received in the light receiving member. According to an optical fiber sensor disclosed in JP-A-2004-20894, the light emitting member, the light receiving member and the calculating part are constructed as modules, respectively, and connected to each other.

In such an optical fiber sensor, however, it is likely to have a loss of light in a light passage between the light emitting member and the light receiving member. For example, the loss of light is likely to occur while the light passes through the optical fiber, and at connecting portions between the ends of the optical fiber and the light emitting member and the light receiving member. With the loss of light, an output signal from the light receiving member is attenuated. In such a case, it is necessary to amplify the output signal in the calculating part. However, a noise signal is amplified with the amplification of the output signal. Therefore, it is necessary to eliminate the noise.

In the light emitting member and the light receiving member, the ends of the optical fiber do not directly contact with a light emitting portion of the light emitting member and a light receiving portion of the light receiving member, to reduce damage to the light emitting portion and the light receiving portion by the ends of the optical fiber. Since the ends of the optical fiber is separate from the light emitting portion and the light receiving portion, the loss of light occurs at these portions.

Further, the surfaces of the light emitting portion and the light receiving portion are generally covered with a light transmittable material such as a resin mold. Thus, the light passage is increased with the thickness of the resin mold, resulting in the loss of light. Not only the light is attenuated while passing through the resin mold, but also the light is likely to diffuse. Thus, the light received in the light receiving member reduces.

Furthermore, on the interfaces between the light emitting and receiving portions and the resin mold, and between the end of the optical fiber and the resin mold, the light generates interface reflection. This interface reflection also results in the loss of light.

### DISCLOSURE OF THE INVENTION

An object of the present invention is to provide an optical fiber sensor with a structure reducing a loss of light at a connecting portion of the optical fiber.

In the optical fiber sensor of the present invention, a first end of an optical fiber is connected to a light emitting member and a second end of the optical fiber is connected to a light receiving member. The light emitting member has a light emitting portion through which light is radiated to the first end of the optical fiber. The light receiving member has a light receiving portion for receiving the light radiated from the second end of the optical fiber therein. The optical fiber has a core portion and a clad portion covering the periphery of the core portion. Further, the light emitting portion is smaller than a sectional area of the core portion of the first end of the optical fiber.

In the optical fiber sensor of the present invention, the amount of light radiated to the outside of an end surface of the first end of the optical fiber from the light emitting portion is reduced. Namely, the loss of light at the connecting portion between the light emitting member and the first end of the optical fiber is reduced. Since the light radiated from the light emitting portion is sufficiently introduced into the first end of the optical fiber, the amount of light used for a sensing operation increases. Also, the light receiving member sufficiently receives the light. Accordingly, the detection accuracy of the sensor improves.

### BRIEF DESCRIPTION OF THE DRAWINGS

FIG. 1 is a transparent plan view of a vehicle having a collision detecting sensor and a collision safety system according to an embodiment of the present invention.

FIG. 2 is an exploded perspective view of a front part of the vehicle including the collision detecting sensor according to the embodiment of the present invention.

FIG. 3 is an explanatory view of the collision detecting sensor according to the embodiment of the present invention.

FIG. 4 is an explanatory view of a connecting portion between a light emitting portion and an end of the optical fiber according to the embodiment of the present invention.

FIG. 5 is an explanatory view of a connecting portion between a light emitting member and the end of an optical fiber as a modification of the embodiment of the present invention.

### BEST MODES FOR CARRYING OUT THE INVENTION

An optical fiber sensor of the invention has an optical fiber, a light emitting member connected to a first end of the optical fiber, and a light receiving member connected to a second end of the optical fiber. The light emitting member emits light to the first end of the optical fiber. The light is transmitted in the optical fiber from the first end to the second end and radiated from the second end toward the light receiving member. The optical fiber sensor determines a change of the light generated while the light passes through the optical fiber, based on a characteristic (e.g., strength, and phase) of light emitted from the light emitting member and a characteristic of light received in the light receiving member. Further, the optical fiber sensor calculates a stress applied to the optical fiber based on the change of the light.

When the stress is applied to the optical fiber, the optical fiber is deformed and the light transmitting characteristic changes at the deformed part of the optical fiber. At the deformed part, the direction of interface between a core portion and a clad portion of the optical fiber on which the light reflects changes. As a result, the traveling direction of the light changes in the optical fiber. Further, the strength of light is likely to reduce. Accordingly, the stress applied to the optical fiber is detected based on the change of the characteristic of the light radiated from the second end of the optical fiber. This optical fiber sensor can be employed to a sensor for a vehicle because it is less likely to be affected by electromagnetic wave.

Hereafter, a preferred embodiment of the present invention will be described in detail with reference to the drawings. In the embodiment, the optical fiber sensor is exemplary used as a vehicle collision detecting sensor for a collision safety system, for detecting a collision of a pedestrian. Here, like components are denoted by like reference characters and a description thereof is not repeated.

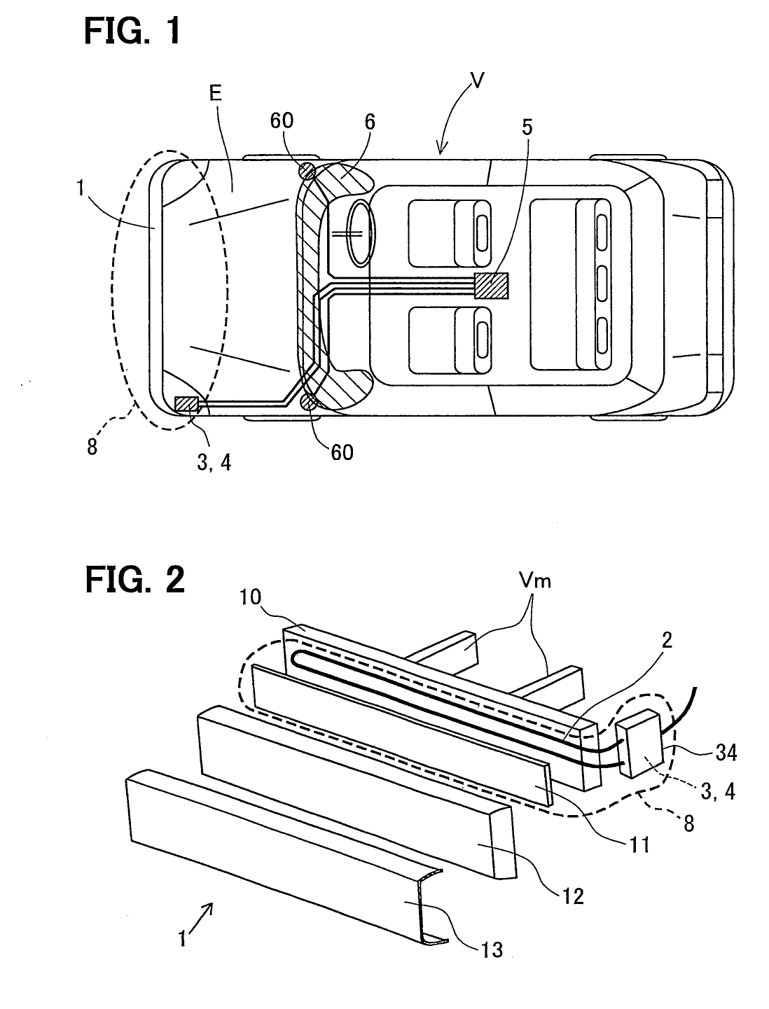

As shown in FIG. 1, the collision detecting sensor 8 is mounted to a front part of a vehicle V for detecting a collision to a bumper 1. The vehicle V has an engine compartment E in front of a passenger compartment. The vehicle V can be any types of vehicle as long as it has the bumper 1. The vehicle V can have a luggage compartment in front of the passenger compartment, instead of the engine compartment E.

The collision detecting sensor 8 has an optical fiber 2, a light emitting member 3, and a light receiving member 4, as shown in FIG. 2. The bumper 1 is located at a front part of the engine compartment E. A bumper reinforcement member 10 is supported by front side members Vm. The optical fiber 2 is disposed along the front surface of the bumper reinforcement member 10. A load plate 11, which substantially has a plate shape, is arranged in front of the optical fiber 2. Further, an absorber 12 is arranged in front of the load plate 11 for reducing an impact. The absorber 12 is made of an elastic material such as foam resin. Further, a bumper cover 13 is arranged in front of the absorber 12.

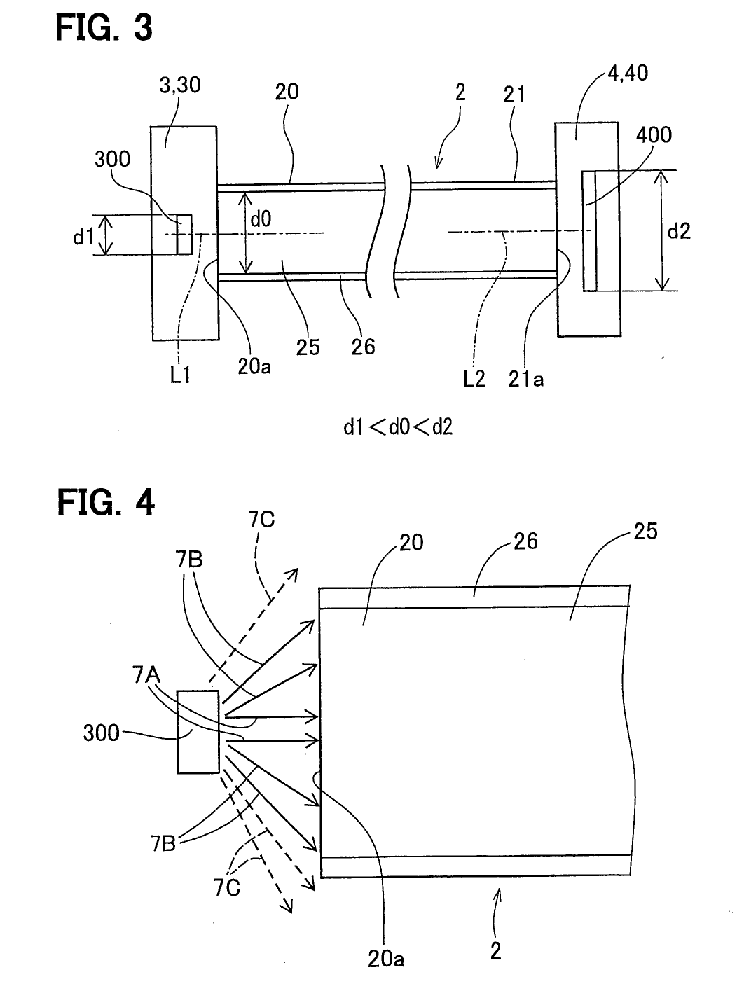

As shown in FIG. 3, the light emitting member 3 is connected to a first end 20 of the optical fiber 2. The light emitting member 3 emits light so that the light travels in the optical fiber 2. The light receiving member 4 is connected to a second end 21 of the optical fiber 2. The light receiving member 4 receives the light that has passed through the optical fiber 2.

The light emitting member 3 and the light receiving member 4 are integrated and accommodated in a case 34. In FIG. 3, the light emitting member 3 and the light receiving member 4 are separately illustrated for a convenience of illustration. The case 34 is located adjacent to a first end (e.g. a passenger seat side) of the bumper reinforcement member 10, as shown in FIG. 2.

The optical fiber 2 has a wire shape having an outer diameter of 2.2 mm. The optical fiber 2 has a core portion 25 and a clad portion 26 covering the periphery of the core portion 25. The core portion 25 is made of a thermosetting acrylic resin. An outer diameter d0 of the core portion 25 is 1.5 mm. The clad portion 26 is integrally formed with the core portion 25 and is made of a fluoro resin (FEP). The clad portion 26 has a thickness of 0.35 mm.

As shown in FIG. 2, the optical fiber 2 is arranged substantially in a U-shape along the front surface of the bumper reinforcement member 10. Specifically, the optical fiber 2 extends from the case 34 to a second end (e.g. a driver seat side) of the bumper reinforcement member 10. The optical fiber 2 turns at the second end of the bumper reinforcement member 10 and further extends to the case 34 along the front surface of the bumper reinforcement member 10.

The light emitting member 3 includes a light emitting diode (LED) 30. The light emitting diode 30 is fixed in the case 34. The LED 30 has a light emitting portion 300 through which the light is radiated to the first end 20 of the optical fiber 2. The first end 20 of the optical fiber 2 is held in the case 34 so that an end surface 20a of the first end 20 is opposed to the light emitting portion 300. Further, the first end 20 of the optical fiber 2 is disposed such that a center of the light emitting portion 300 is located on an axis L1 of the first end 20.

The LED 30 has a resin mold made of a light transmittable material. The resin mold covers the periphery of the light emitting portion 300. The light emitting portion 300 is smaller than a sectional area of the core portion 25. Specifically, the light emitting portion 300 has an outer dimension that is smaller than a circle of 1.5 mm in diameter. In a case that the light emitting portion 300 has a circular shape, a diameter d1 of the light emitting portion 300 is smaller than the diameter d0 of the core portion 25. In the embodiment, the light emitting portion 300 has a square shape having the side of 0.28 mm.

The light receiving member 4 is housed in the case 34 with the light emitting member 3. The light receiving member 4 includes a photo diode (PD) 40. The PD 40 has a light receiving portion 400 for receiving light radiated from the second end 21 of the optical fiber 2. The PD 40 is fixed in the case 34. The second end 21 of the optical fiber 2 is held in the case 34 so that an end surface 21a of the second end 21 is opposed to the light receiving portion 400. Further, the second end 21 of the optical fiber 20 is disposed such that a center of the light receiving portion 400a is located on an axis L2 of the second end 21.

The light emitting portion 400 is covered with the resin mold, which is made of the light transmittable material. The light receiving portion 400 is larger than the sectional area of the core portion 25. Specifically, the light receiving portion 400 has an outer dimension that is larger than a circle of 1.5 mm in diameter. In the embodiment, the light receiving portion 400 has a square shape having the side of 2.0 mm.

The case 34 has two holes at positions corresponding to the LED 30 and the PD 40. The first end 20 and the second end 21 of the optical fiber 2 are inserted and fixed in the holes, respectively. Further, the first end 20 of the optical fiber 2 is fixed in a condition that the end surface 20a is slightly separate from the surface of the LED 30. Likewise, the second end 21 of the optical fiber 2 is fixed in a condition that the end surface 21a is slightly separate from the surface of the PD 40.

The light emitting member 3 and the light receiving member 4 are connected to a calculating part 5, as shown in FIG. 1. The calculating part 5 controls the light to be emitted from the LED 30. Specifically, the calculating part 5 controls an electric current supplied to the LED 30, thereby to control the amount or strength of light emitted from the LED 30. The PD 40 outputs the signal to the calculating part 5 when receiving the light from the second end 21 of the optical fiber 2.

The calculating part 5 determines a condition of light passing through the optical fiber 2, that is, a collision load applied to the optical fiber 2, based on the signal. Specifically, the calculating part 5 compares the characteristic (e.g., strength, phase) of the light received in the PD 40 to the characteristic of the light emitted from the LED 30, thereby to determine the condition of the optical fiber 2. Based on the condition of the optical fiber 2, the calculating part 5 determines an object collided to the bumper 1.

In the embodiment, the calculating part 5 also functions as a calculating means of the collision safety system for protecting the pedestrian collided with the bumper 1. That is, the calculating part 5 operates the collision safety system when it is determined that the object collided with the bumper 1 is the pedestrian. As a pedestrian protecting device, for example, a pillar air bag 6 is operated by the collision safety system.

In the collision detecting sensor 8, an electric current is supplied to the LED 30 by an instruction of the calculating part 5, so the LED 30 emits light. In the LED 30, the outer shape of the light emitting portion 300 is smaller than the circle of 1.5 mm in diameter, and the surface of the LED 30 is slightly separate from the end surface 20a of the optical fiber 2. When the LED 30 emits light, the light radiated from the light emitting portion 300 diffuses.

In the embodiment, the light emitting portion 300 is smaller than the sectional area of the core portion 25 so that the light radiated from the light emitting portion 300 is sufficiently radiated to the end surface 20a of the optical fiber 2. As shown in FIG. 4, the light radiated from the light emitting portion 300 diffuses and travels in different directions. A light 7A that travels along the axis L1 of the first end 20 is radiated to the core portion 25 and enters the optical fiber 2. A light 7B that travels in directions separate from the axis L1 can be radiated to the core portion 25 and received in the core portion 25.

Since the light emitting portion 300 is smaller than the sectional area of the core portion 25 (d1<d0), the amount of light that will be radiated to the outside of the core portion 25 (e.g., light 7C) is reduced. Accordingly, the loss of light at the connecting portion between the light emitting member 3 and the optical fiber 2 is reduced. The amount of light without contributing to the sensing operation is reduced. In other words, the light radiated from the light emitting portion 300 is sufficiently introduced in the optical fiber 2 and used for the sensing operation.

The smaller the light emitting portion 300 is, the more the light radiated outside of the core portion 25 reduces. The size of the light emitting portion 300 with respect to the optical fiber 2 is decided in accordance with a distance between the light emitting portion 300 and the end surface 20a of the first end 20 of the optical fiber 2, and the light radiated from the light emitting portion 300. Further, it is preferable that a diameter of light radiated to the first end 20 of the optical fiber 2 is smaller than the diameter d0 of the core portion 25 at the end surface 20a.

The light that has passed through the optical fiber 2 is radiated to the PD 41 from the second end 21 of the optical fiber 2. Similarly, the light radiated from the second end 21 diffuses. In the embodiment, the PD 40 is larger than the sectional area of the core portion 25 so that the light is sufficiently received in the PD 40. Similarly, the loss of light is reduced at the connecting portion between the optical fiber 2 and the light receiving portion 4.

The larger the light receiving portion 400 is, the less the light radiated outside of the light receiving portion 400 is. The size of the light receiving portion 400 with respect to the optical fiber 2 is decided in accordance with the distance between the end surface 21a of the second end 21 of the optical fiber 2 and the light receiving portion 400 and the light radiated from the second end 21.

Accordingly, even if the light radiated from the light emitting portion 300 diffuses, the light is received in the core portion 25 of the first end 21 of the optical fiber 2 having the sectional area larger than the dimension of the light source. Likewise, even if the light radiated from the second end 21 of the optical fiber 2 diffuses, the light is received in the light receiving portion 400 having the dimension larger than that of the end surface 21a of the second end 21. The loss of light resulting from the diffusion of light is reduced.

Therefore, the light transmission at the connecting portions between the optical fiber and the light emitting member 3 and the light receiving member 4 improves. Furthermore, a sensing performance of the collision detection sensor 8 improves without requiring an increase of the degree of light emitted from the LED 3. Since the light is sufficiently introduced in the optical fiber 2, the light receiving member 4 can output light with a sufficient strength. Therefore, the necessity to amplify the signal is reduced. Further, it is easy to process the output signal. Furthermore, the detection accuracy improves.

In the collision safety system of the embodiment, the calculating part 5 controls the LED 30 to emit light. The PD 40 receives the light from the optical fiber 2 and outputs the signal to the calculating part 5. The calculating part 5 determines the change of light passing through the optical fiber 2 based on the characteristic of light emitted from the LED 30 (the light instructed to the LED 30) and the characteristic of light received by the PD 40, thereby to determine the condition of the optical fiber 2.

When it is determined that the condition of the optical fiber 2 is changed by the collision at the bumper 1, a pillar air bag expansion device 60 is operated to expand the pillar air bag 6. Accordingly, it is less likely that the object collided with the bumper 1, in particular, the pedestrian will directly strike to a bonnet and a pillar of the vehicle, thereby reducing an impact of the strike.

Accordingly, the loss of light is reduced in the collision detecting sensor 8. Therefore, the collision to the bumper 1 is detected with improved accuracy. Further, the harm to the pedestrian collided with the bumper 1 is reduced, and passive safety of the pedestrian improves.

In the above-described embodiment, the calculating part 5 also functions as the calculating part of the collision safety system. However, the calculating part 5 of the collision detecting sensor 8 and the calculating part of the collision safety system can be provided separately. The calculating part 5 of the collision detecting sensor 8 can be integrated with the light emitting member 3 and the light receiving member 4.

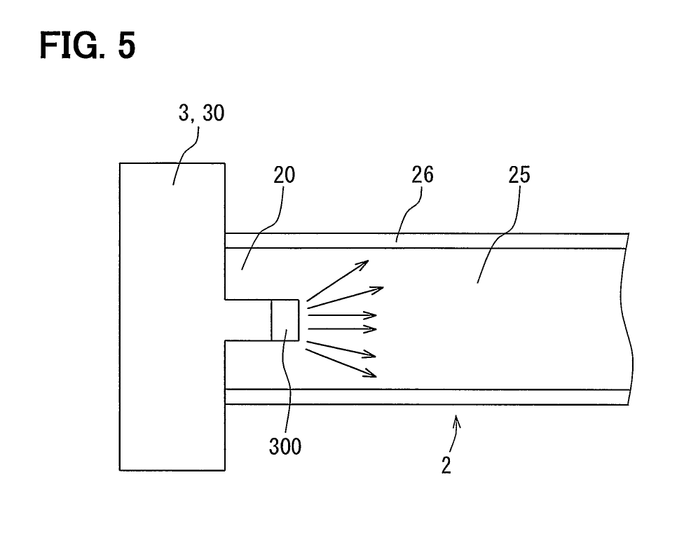

In the above-described embodiment, the light emitting portion 300 is disposed to oppose the end surface 20a of the first end 20 of the optical fiber 2. Instead, the light emitting portion 300 can be disposed, as shown in FIG. 5. That is, the light emitting portion 300 can be embedded in the core portion 25 of the optical fiber 2. In this structure, the light from the light emitting portion 300 is fully radiated into the core portion 25. Thus, the loss of light at the connecting portion between the light emitting member 3 and the optical fiber 2 is further reduced.

In the above-described embodiment, the optical fiber 2 is made of resin. The core portion 25 and the clad portion 26 are made of materials having a different reflective index. In stead of the resinous optical fiber 2, a glass fiber 2 can be used as long as the core portion 25 and the clad portion 26 have the different reflective index. The difference between the reflective indexes of the core portion 25 and the clad portion 26 is not limited to a particular value. Also, the optical fiber 2 has any diameter and any length. A general optical fiber used in a conventional optical fiber sensor can be used in the optical fiber sensor of the invention.

In addition, the light emitting member 3 is preferably arranged such that an axis of the light radiated from the light emitting portion 300 coincides with the axis L1 of the first end 20 of the optical fiber 2. Also, it is preferable that the surface of the light emitting portion 300 is perpendicular to the axis L1 of the first end 20 of the optical fiber 2.

In the above-described embodiment, the light emitting member 3 has the LED 30, as a light source. However, the light source is not limited to the LED 30. The light emitting portion 300 can emit any types of light as long as the light can travel through the optical fiber 2 from the first end 20 to the second end 21 and is radiated from the second end 21. Also, it is preferable that the light emitted from the light emitting member 3 has a single wave length.

Similarly, the light receiving portion 4 is preferably arranged such that an axis of the light receiving portion 400 coincides with the axis L2 of the second end 21 of the optical fiber 2. Also, it is preferable that the surface of the light receiving portion 400 is perpendicular to the axis L2 of the second end 21 of the optical fiber 2.

In the above-described embodiment, the light receiving member 4 includes the photo diode (PD). However, the light receiving portion 400 can be provided of any other elements as long as it can receive the light from the second end 21 of the optical fiber 2 and detects the change of the light.

Further, the light emitting portion 300 is smaller than the sectional area of the core portion 25 of the optical fiber 2. Here, the sectional area is measured in a cross-section that is perpendicular to the axis of the core portion 25. That is, the outer dimension or diameter d1 of the light emitting portion 300 is smaller than the outer diameter d0 of the core portion 25. Preferably, the light emitting portion 300 is included in the outer shape of the core portion 25 when viewed along the axis L1 of the first end 20 of the optical fiber 2. More preferably, the diameter of the light radiated from the light emitting portion 300 is smaller than the diameter d0 of the core portion 25 at the end surface 20a of the first end 20 of the optical fiber 2.

The optical fiber sensor of the present invention is exemplary employed to the collision detecting sensor 8 for detecting the collision of a vehicle with a pedestrian. It is less likely that the optical fiber sensor performing the sensing operation by using the light traveling through the optical fiber 2 will be affected by an electromagnetic wave. Therefore, it is not necessary to have an electromagnetic wave proof structure.

Accordingly, the optical fiber sensor having the above-described structure is suitably used as a vehicle sensor that needs electromagnetic compatibility (EMC). In the optical fiber sensor of the present invention, the length of the optical fiber 2 is increased because the loss of light is reduced. Therefore, the optical fiber sensor of the present invention is suitably used as the collision detecting sensor mounted to a bumper 1 of the vehicle. In the collision detecting sensor, the collision of the pedestrian is determined by the calculating part 5. Here, the pedestrian is not limited to a person who is walking on a street, but may include any people such as a person who are riding a bicycle.

Additional advantages and modifications will readily occur to those skilled in the art. The invention in its broader terms is therefore not limited to the specific details, representative apparatus, and illustrative examples shown and described.

1. An optical fiber sensor comprising:
an optical fiber having a core portion and a clad portion covering the core portion;
a light emitting member connected to a first end of the optical fiber, the light emitting member having a light emitting portion for emitting light to the first end of the optical fiber; and
a light receiving member connected to a second end of the optical fiber, the light receiving member having a light receiving portion for receiving light radiated from the second end of the optical fiber, wherein the light emitting portion is smaller than a sectional area of the core portion,
the light emitting portion is disposed such that a center thereof is aligned with an axis of the optical fiber, and
the light receiving portion is disposed such that a center thereof is aligned with the axis of the optical fiber.

2. The optical fiber sensor according to claim 1, wherein the light receiving portion is larger than the sectional area of the core portion.

3. The optical fiber sensor according to claim 1, wherein the light emitting portion has an outer diameter that is smaller than a diameter of the core portion.

4. The optical fiber sensor according to claim 1, wherein the light emitting portion is disposed to oppose an end surface of the first end of the optical fiber so that a diameter of the light radiated to the first end of the optical fiber is smaller than a diameter of the core portion at the end surface of the optical fiber.

5. The optical fiber sensor according to claim 1, wherein the light emitting portion is embedded in the first end of the optical fiber.

6. The optical fiber sensor according to claim 1, further comprising a calculating part connected to the light emitting member and the light receiving member, wherein the calculating part detects a stress applied to the optical fiber based on a characteristic of the light emitted from the light emitting portion and a characteristic of the light received in the light receiving portion.

7. A collision detecting sensor for a vehicle, having the optical fiber sensor as in claim 1, wherein the optical fiber sensor detects a collision of a pedestrian to the vehicle.
